(19) United States
(12) Patent Application Publication
(10) Pub. No.: US 2024/0144956 A1
(43) Pub. Date: May 2, 2024

(54) SYSTEMS FOR PROVIDING REAL-TIME FEEDBACK TO REDUCE UNDESIRED SPEAKING PATTERNS, AND METHODS OF USING THE SAME

(71) Applicant: CDC Phone App IP 2023 LLC, New York, NY (US)

(72) Inventors: Campbell Davis CONARD, Chicago, IL (US); Simon EDWARDS, London (GB); Manish AHUJA, Noida (IN); Hadi DBOUK, Beirut (LB)

(73) Assignee: CDC Phone App IP 2023 LLC, New York, NY (US)

(21) Appl. No.: 18/497,967

(22) Filed: Oct. 30, 2023

Related U.S. Application Data
(60) Provisional application No. 63/381,642, filed on Oct. 31, 2022.

(51) Int. Cl. G10L 25/69; G10L 17/06; G10L 17/26

(52) U.S. Cl. CPC G10L 25/69; G10L 17/06; G10L 17/26

(57) ABSTRACT

A system and method to identify filler speech and deliver real-time feedback to the speaker for correction. The system receives a live audio signal from a user's speech, analyzes the audio signal for filler speech, verifies the speaker's identity, and, if filler speech is detected from the verified user, provides discreet sensory feedback to make the speaker aware of this behavior so it can be corrected in real time with the added benefit of helping the speaker to improve their speech behavior by eliminating the use of filler speech.

### FIELD OF THE INVENTION

The present invention relates to systems and methods for improving speech behavior and reducing the use of filler words, such as “like” or “you know,” using discreet real-time feedback to a speaker during spontaneous face-to-face conversations, which current alternatives are unable to do.

### BACKGROUND OF THE INVENTION

The use of vocal disfluencies, or “filler speech,” is common in casual conversations and professional presentations. Examples of filler words include “like,” “you know,” and “really,” and examples of filler sounds include “uhm,” “uh,” and nervous laughter or giggling. While filler speech may be accepted in some contexts, excessive use of filler speech may have negative consequences, such as distracting listeners from the content of the speaker's statements, reducing the speaker's credibility or creating an undesirable impression that the speaker is immature, nervous, unprepared, and/or unsure of themselves. There is thus a need for correcting speech behavior for individuals who use excessive filler speech. However, speakers who frequently use excessive filler speech often do so unconsciously and habitually as a learned behavior and are therefore not well-suited to correcting their own behavior. Identifying and notifying the speaker publicly of their behavior, especially in the presence of the speaker's peers, presents a risk of social stigma or shame.

Current solutions to correcting undesirable speech behavior include the use of personal computers and display screens to provide visual feedback to speakers; recording speech, counting filler words, and displaying statistics after speaking has concluded; and counseling with a speech coach. While these conventional approaches may prove helpful, they generally require advance planning and set-up (e.g., arranging display screens), are only available at select times (e.g., during a formal speech or video conference call), and are ineffective for providing real-time feedback during spontaneous face-to-face conversations, when feedback is most needed and effective.

Therefore, a means for improving speech by reducing the use of excessive filler speech during spontaneous face-to-face conversations, and doing so discreetly, without causing shame or discomfort to a speaker, is needed.

### SUMMARY OF THE INVENTION

The present invention is inclusive of systems and methods for reducing undesirable speech behavior by detecting the occurrence of filler speech and providing discreet real-time feedback to the speaker during spontaneous face-to-face conversation for correction of the undesirable behavior.

Systems according to the present invention have a processor, memory accessible by the processor, and programmed instructions and data stored in the memory and executable by the processor. The system is configured to: receive an audio signal at an input device, preferably a smart phone, based on the speech of an individual within proximity of the system; assess the audio signal for the presence of one or more instances of filler speech; assess the audio signal to verify a speaker identity to determine if the audio signal originates from speech of a targeted user of the device; and upon detecting the presence of at least one instance of filler speech and confirming that the audio signal originates from a verified targeted user of the device, outputting a discreet sensory signal, preferably a haptic signal using a smart phone, watch, or other potable device, to the targeted user informing them of the detection of filler speech. The system is configured to output discreet sensory signals in the form of one or more of: haptic signals, auditory signals, and visual signals. The real time sensory signals bring awareness to the speaker of the use of undesired filler speech discreetly so the speaker can practice a competing response such as a pause, instead of the filler word, without others being aware of the signal. The system may also record a history of detected filler speech for review by a user.

The system is configured to assess audio signals for detection of filler speech in the form of filler words and filler sounds, and to confirm the presence of at least one instance of filler speech in an audio signal upon detecting the presence of at least one instance of either a filler word or a filler sound. Audio signals are assessed for the presence of filler words using a text-classification model and assessed for the presence of filler sounds using an acoustic-classification model.

The text-classification model converts an audio signal to a text transcript and uses text-searching of the text transcript for words matching a predetermined list of filler words, the predetermined list of filler words being stored in the memory. Optionally, the system may be further configured, upon detecting a filler word in a text transcript, to identify surrounding words in proximity to the detected filler word and determine whether the detected filler word was used in a proper non-filler context based on the surrounding words. The system may also be configured for a user to selectively update the predetermined list of filler words to either remove or add words that the system will use for the detection of filler words.

The acoustic-classification model compares a waveform of an audio signal to waveforms of sound files of predetermined filler sounds to determine if a filler sound is present in the audio signal based on one or more matching waveforms. The sound files of the predetermined filler sounds are stored in the memory, and the system may be configured for a user to selectively update the sound files of predetermined filler sounds to either remove or add sound files, to thereby add or remove sounds that the system will use for the detection of filler sounds.

The system is configured to verify speaker identity by comparing a waveform of the audio signal to one or more waveforms from sound files of user voice recordings, the sound files of the user voice recordings being stored in the memory.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, explain the principles of the invention.

### BRIEF DESCRIPTION OF THE DRAWINGS

Further features and advantages of the invention can be ascertained from the following detailed description that is provided in connection with the drawings described below:

FIG. 1 shows an example of a process for detecting and providing real-time feedback informing on the use of filler speech;

FIG. 2 shows an example of a system for use in performing the process of FIG. 1;

FIG. 3 shows the results of a first working example of a text-classification model in the process of FIG. 1;

FIG. 4 shows the results of a second working example of a text-classification model in the process of FIG. 1; and

FIG. 5 shows the results of a working example of an acoustic-classification model in the process of FIG. 1.

### DETAILED DESCRIPTION OF THE INVENTION

The following disclosure discusses the present invention with reference to the examples shown in the accompanying drawings, though does not limit the invention to those examples.

The use of all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small to not appreciably detract from the identified property or circumstance. The exact degree of deviation allowable in each circumstance will depend on the specific context, as would be understood by one having ordinary skill in the art.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

As used herein, the term “filler speech” will be understood as encompassing filler words, filler sounds, vocal disfluencies, and other undesirable speaking patterns and behaviors, unless otherwise made clear in context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of systems and methods for reducing the use of filler speech, and providing discreet real-time feedback to the speaker for correction of the same. Undesirable speaking patterns and behavior may include an excessive frequency of use of filler words, filler sounds and/or vocal disfluencies, though may further include the use of socially unacceptable words and/or phrases (e.g., curse words), negative self-talk (e.g., self-disparaging words or phrases), and patterns/behaviors outside of pre-established norms (e.g., speaking at a speed that is either too fast or to slow compared to a predetermined speech rate based, for example, on a predetermined words-per-minute rate).

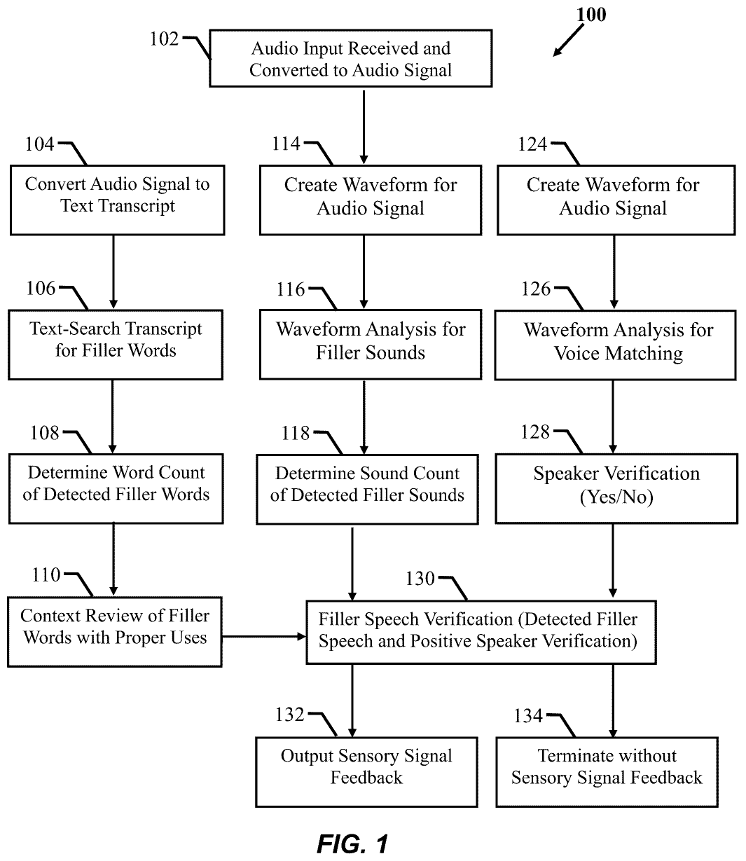

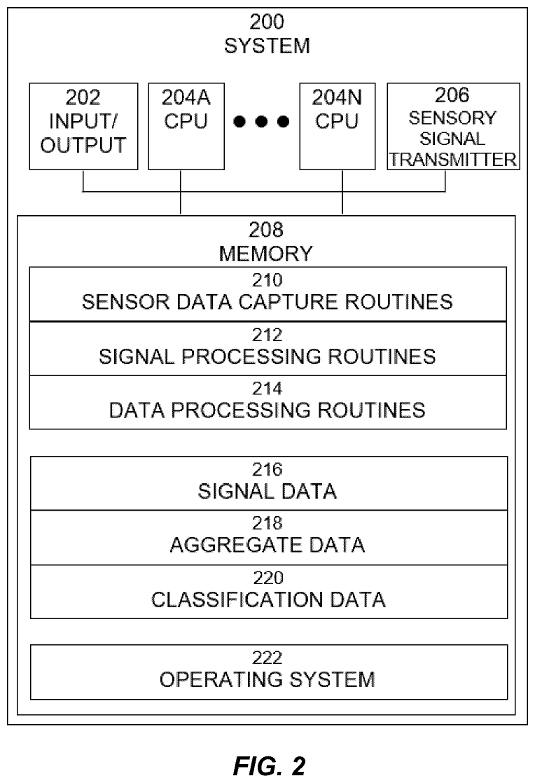

FIG. 1 shows one example of a process 100 for detecting the presence of filler speech and providing real-time feedback to a user for correction of their speech behavior. FIG. 2 shows one example of a system 200 for performing the process 100.

Generally, the process 100 includes a first step 102 of receiving an audio signal representing the speech of an individual. The audio signal is stored in a temporary memory (e.g., an audio buffer) of the system 200 while a processor 204 executes three separate assessments of the audio signal, including: [1] a filler word assessment for detection of filler words; [2] a filler sound assessment for detection of filler sounds; and [3] a speaker verification assessment for confirmation of a verified target speaker. In the illustrated example, the three assessments [1]-[3] are performed in parallel, however in other examples the three assessments may instead be performed in sequence, one after another and in any desired order. Optionally, the system 200 may be configured for a user to disable the speaker verification assessment such that process 100 requires only the filler words assessment and filler sound assessment.

In a filler word assessment, in a step 104, the audio signal is converted into a text transcript via one or more speech-to-text models. The speech-to-text model has two parts, an acoustic model and a language model. First the acoustic model takes audio as input and converts it to a probability over characters in the alphabet. Then the language model helps to turn these probabilities into words of logical language. The language model assigns probabilities to words and phrases based on statistics from training data. Suitable speech-to-text algorithms include, though are not limited to, speech recognition and transcription programs available through the iOS mobile operating system from Apple, Inc. and the Android operating system from Google, LLC.

In a step 106, the text transcript is then searched for filler words. A list of filler words may be stored in the memory 208 as one or more text files, and the processor 204 may communicate with the memory 208 to identify filler words that are to be searched for within a text transcript. Filler words may be any word that is determined in advance to be commonly used to fill pauses or gaps in speech, without contributing meaningfully to the content of the speech. Examples of filler words include, though are not limited to: “like,” “you know,” and “really”.

In some examples the memory 208 may be pre-loaded with a predetermined list of filler words prior to delivery to a user, and a user may thereafter alter the stored list of filler words. For example, an extensive listing of words that are determined in advance as proposed filler words may be stored in the memory 208, and a user may interact with the system 200 via an input device 202 to select and/or deselect specific words from that predetermined list that they would like the system 200 to treat as filler words. In some examples, a user may add words to the predetermined listing of words, which may be done through an input device 202 in the form of either a typed-text input or a speech-to-text input. By enabling a user to edit of the listing of filler words, a user may customize the system 200 to identify and provide feedback based on speech behaviors specific to the individual user.

In a step 108, the processor 204 determines a word count of filler words identified in the text transcript of the audio signal. If the text-search concludes without any filler words identified in the text transcript, then the word count will be set to a zero count (i.e., no filler words present). If the text-search concludes with a finding of one or more filler words in the text transcript, then the word count will be set to a non-zero count, which may be done by recording the presence of at least one filler word or recording an exact number of filler words detected in the text transcript. In some examples the word count may be set to an exact number of filler words detected in the text transcript (e.g., ten filler words detected), and may further identify a count of each specific filler word detected (e.g., one count of “really,” two counts of “you know,” and seven counts of “like”).

In some examples there may be an optional step 110 in which the processor 204 performs a context review of the results from the text-search to determine if any of the filler words detected by the text-search (if any) were in fact used in proper context (i.e., not as a filler word). For example, the word “like” may be the most commonly used filler word, though also has proper non-filler uses, such as when used to convey similarities between two separate things or events. A context review may be used to identify any such proper uses of a filler word to avoid a false-positive report of filler speech.

When including a step 110 for a context review, the list of filler words stored in the memory 208 may include additional information identifying those listed filler words that also have proper contextual uses. When a text search concludes with a finding of one or more filler words, the processor 207 may communicate with the memory 208 to determine if any of the detected filler words are known to have proper contextual uses. If one or more detected filler words are identified as having proper contextual uses, the processor 208 then makes a further search of the text transcript for each occurrence of those detected filler words with proper contextual uses to identify a number of words preceding and following each occurrence of each such filler word. For example, if one or more occurrences of the word “like” is detected in the text transcript, then the processor 207 will search the text transcript for each occurrence of the word “like” and will further identify a number of words that precede and a number of words that follow each such occurrence. A context review may be made with identification of any number of preceding and following words, including for example three words preceding and following, five words preceding and following, or ten or more words preceding and following.

Upon identifying the surrounding words (preceding and following) for an occurrence of a filler word, the processor 204 then uses a text-classification model to determine whether the surrounding words are indicative that the corresponding occurrence of the filler word was in fact a proper contextual use or a filler use. If the processor 204 determines that one or more occurrences of a detected filler word were proper contextual uses, then the processor 204 updates the results from the text-search to decrease the word count for the corresponding detected filler word by the number of proper contextual uses identified for that filler word, such that the updated word count (step 108) more accurately represents a true count of filler uses for the corresponding filler word.

In a filler sound assessment, in a step 114, the processor 204 creates a waveform of the audio signal, and in a step 116 the processor 204 uses an acoustic-classification model to determine if the audio signal contains a filler sound. Suitable acoustic-classification models include, though are not limited to, a CoreML model available from Apple, Inc. or a TensorFlow Lite ML model available from Google, LLC. The acoustic-classification model is trained on dataset of common filler sounds, such as “ums”, “uhs”, and giggles or laughter, as well as other speech and background sounds.

A collection of predetermined filler sounds may be stored in the memory 208 as one or more sound files, and the processor 204 may communicate with the memory 208 to perform a waveform analysis in which one or more waveforms created from an audio signal are compared against waveforms of stored filler sounds to identify the presence of a filler sound in a received audio signal. Positive identification of a filler sound may be conditioned on a predetermined confidence level, for example, based on a minimum percentage matching (e.g., 75%) between a waveform of an audio signal and a waveform of a stored filler sound.

In some examples the memory 208 may be pre-loaded with a predetermined list of filler sounds prior to delivery to an end user, and a user may thereafter alter the stored list of filler sounds. For example, a system 200 may be provided with an extensive listing of sounds that are determined in advance to be known filler sounds, and a user may interact with the system 200 via an input device 202 to select and/or deselect specific sounds from the predetermined list that they would like the system 200 to treat as filler sounds. In some examples, a user may add further sounds to the predetermined listing of filler sounds, which may be done via an audio input device 202. By enabling a user to edit of the listing of filler sounds, a user may customize the system 200 to identify and provide feedback based on speech behaviors specific to the individual user.

In a step 118, the processor 204 determines a sound count of filler sounds identified in the audio signal. If the processor 204 does not identify any filler sounds in the audio signal, then the sound count is set to a zero count (i.e., no filler sounds present). If the processor 204 identifies one or more filler sounds in the audio signal, then the sound count is set to a non-zero count, which may be done by recording the presence of at least one filler sound or recording an exact number of filler sounds detected. In some examples, the processor 204 may identify the exact number of filler sounds detected (e.g., five filler sounds detected) and may further identify a count for each specific filler sound detected (e.g., one count of “uhm,” two counts of “uh,” and three counts of “giggling”).

In a speaker verification assessment, in a step 124, the processor 204 analyzes a received audio signal and creates one or more waveforms of the audio signal, and in a step 126 the processor 204 verifies a speaker identity using a voice matching algorithm to compare the waveform created from the audio signal against one or more pre-stored waveforms to determine if the audio signal contains speech originating from a verified speaker who is a targeted user for speech behavior correction. The waveforms used for speaker verification, as well as those used for sound classification, may include one or more mel-spectrograms. Suitable voice matching algorithms include, though are not limited to Pytorch, or NeMo Speaker Recognition models available from Nvidia Corporation.

The voice matching algorithm is trained on a dataset of speech files recorded into the system 200 prior to the delivery to the end user. During a system initialization and setup, the end user creates one or more unique recorded speech files for comparison purposes. The unique recorded speech files may be updated at any time to reflect a more accurate auditory environment for the speaker. For example, a user may record multiple speech files recording their speech in several different environments and/or contexts (e.g., low ambient-noise environment; medium ambient-noise environment; high ambient-noise environment; one-on-one conversation; public presentation; large social gathering; etc.) and the system 200 may be adapted to recognize an environment and/or context and select a corresponding speaker voice recording for use in speaker verification assessment. The system 200 may also be adapted for a user to preemptively select an environment and/or context. Preferably, the recorded speech files comprise statements spoken by the user based on prompts provided by the system 200, with the system 200 programmed to prompt a user for specific statements that are determined in advance as most useful for use in confirming a speaker's identity and in identifying common filler speech. For example, the system 200 may require a user to recite statements into an audio input device 202, which may include statements imitating common filler words and sounds.

Recorded speech files may be stored in the memory 208 as one or more sound files, and the processor 204 may communicate with the memory 208 to compare one or more waveforms of audio signals against one or more waveforms from the stored speech files to determine if the audio signals contain speech originating from a speaker who is verified as a targeted user of the system for speech behavior correction. Positive identification of a verified speaker may be conditioned on a predetermined confidence level, for example, based on a minimum percentage matching (e.g., 75%) between a waveform of an audio signal and a waveform of a stored speech file. Comparison of the audio signal and speech file waveforms may include assessing cosine similarity of the waveforms.

In some examples, in addition to the system 200 prompting a user to train the voice matching algorithm by reciting predetermined statements into an audio input, a user may provide additional statements of their choice for further training the voice matching algorithm. In some examples, training of the voice matching algorithm may continue after system initialization and setup, and during operational use, so that the voice matching algorithm may be continually improved for increased accuracy in correctly verifying a speaker as a targeted user as the system continues to receive further audio inputs of user during spontaneous, real-time conversations.

In a step 128, the processor 204 confirms whether an audio signal contains speech originating from a verified speaker who is a targeted user of the system 200 with either a positive identification setting (e.g., 1, Yes, True, etc.) or a negative identification setting (e.g., 0, No, False, etc.).

In a step 130, the processor 204 verifies the occurrence of filler speech by a verified speaker. If the word count from the text-search confirms the presence of one or more filler words and/or the sound count from the audio signal analysis confirms the presence of one or more filler sounds, then the processor 204 confirms the presence of filler speech. If the system 200 is adapted for identifying specific occurrences of filler words and/or filler sounds, then the processor 204 may save this additional information to the memory 208. If an identification setting from the speaker verification assessment confirms that the audio signal contains speech from a verified speaker, then the processor 204 confirms that the filler speech originated from a targeted user for speech behavior correction. When the processor 204 confirms there has been at least one instance of filler speech with a positive speaker verification of a targeted user, then the process proceeds to a step 132 in which the processor 204 triggers a sensory signal transmitter 206 to provide real-time feedback to a user, informing the user of their filler speech, by outputting a discreet sensory signal to the targeted user. If the processor 204 determines that there has not been any instance of filler speech, or that that there is a negative speaker identification in the absence of a targeted user, then the process terminates at a step 134 without any sensory signal feedback to the user.

Optionally, the system 200 may be configured for a user to selectively disable the speaker verification assessment. In such scenarios, the process 100 will omit steps for the speaker verification assessment (steps 124,126, 128) and step 130 will require only a confirmation that there has been at least one instance of filler speech for the process 100 to then proceed to step 132 for the processor 204 to trigger the sensory signal transmitter 206 to feedback to the user. Without being bound by theory, it is possible that speaker verification may be difficult in environments with high levels of background noise (e.g., large crowds; loud machinery; etc.). In such environment, a user may selectively disable the speaker verification assessment so that the system 200 may more reliably identify occurrences of filler speech without requiring confirmation of speaker identity, as this may provide a more reliable identification of filler speech in such environments.

In some examples, the system 200 may output a sensory signal to a targeted user for every instance of detected filler speech by the targeted user. In other examples, the system 200 may output a sensory signal to a targeted user only after detecting a predetermined number of instances of filler speech (e.g., three occurrences, five occurrences, seven occurrences, etc.) within a predetermined period of time (e.g., ten seconds, thirty seconds, sixty seconds, etc.). In some examples the system 200 may be adapted to output a predetermined number of sensory signals (e.g., one or more individual signal pulses), and in other examples the processor 204 may command the sensory signal transmitter 206 to output sensory signals for a predetermined duration (e.g., repeat pulses for thirty seconds straight) with the option for a user to interact with the system 200 to trigger an early termination of the sensory signals before completion of the predetermined duration (e.g., by triggering an alert termination switch).

Optionally, the system 200 may be configured for a user to selectively set any of: a number of filler speech occurrences before a sensory signal is output, a period of time within which a predetermined number of filler speech occurrences must be detected before a sensory signal is output, and/or a duration over which a sensory signal may be repeatedly output. Enabling the selective setting of these parameters enables a user to adapt the system 200 to provide feedback most conducive to correcting their specific speech behavior. For example, if a user has a relatively high frequency of filler speech, then it may be undesirable for the system 200 to provide sensory feedback for every single occurrence of filler speech as a high number of sensory signals may prove distracting to the user, whereas a single sensory signal after multiple filler speech occurrences may prove sufficient in alerting the user to correct their speech behavior. Without being bound by theory, it is also expected that if the system 200 is set to require multiple occurrences of filler speech within a predetermined period of time then there will be fewer instances of false-positive sensory feedback based on the detection of one or more filler words that are in fact used in a proper context (e.g., the word “like” used in a comparison context).

The system 200 is adapted to provide sensory signal feedback as discreet sensory signals that are readily capable of perception by a targeted user, though of relatively reduced perception or entirely imperceptible to others. Examples of sensory signals that may be used with the present invention include, though are not limited to: haptic signals (e.g., mechanical vibrations or electrical stimulations), auditory signals, and visual signals (e.g., light emitted from a light source). Examples of sensory signaling devices for generating discreet sensory signals include, though are not limited to: mobile phones, wristwatches, earpieces, and any other electronic devices that may be worn or carried in close proximity to a user's body.

In one example, a wristwatch may provide a discreet sensory signal to a user in the form of a haptic signal that is perceptible to only the user due to the skin contact of the wristwatch. In another example, an electronic earpiece may be used to generate a sensory signal to a user in the form of a low-intensity auditory signal that is perceptible to only the user due to the proximity of the earpiece to the user's ear canal. In a further example, a light source on an inner surface of eyeglasses may be used to generate a visual sensory signal to a user in the form of a low-intensity light signal that is perceptible to only the user due to the proximity of the eyeglasses to the user's eyes. In a yet further example, the screen of a phone, tablet, laptop or other such consumer electronic device may emit a discreet flash to provide a visual sensory signal to a user. Generally, any small electronic device may be adapted to provide one or more discreet sensory signals to a user if it is regularly in close body proximity with a user. For example, mobile phones may be programmed to generate haptic signals that are detectable based on proximity of the mobile phone to a user's body while the phone is carried; articles of clothing and neck jewelry may be adapted for generating haptic signals based on body contact; ear jewelry may be adapted for generating haptic signals and/or auditory signals based on body contact and/or proximity to the ear canal; etc.

In some examples, the system 200 may be adapted to provide additional functionality beyond the delivery of sensory signals alone. For instance, when using a sensory signaling device with a relatively more robust computing system (e.g., a smartphone or smartwatch), the system may be adapted to generate usage reports identifying the specific filler speech that was identified as basis for triggering a sensory signal, the number of occurrences of each specific filler speech identified, and/or a transcript of an audio signal that was identified as containing the filler speech. In some examples, the system may also provide historical data reporting the number of occurrences that filler speech has been identified over an extended period of time, with a count of the occurrences on individual instances within that extended period of time (e.g., a count on the total number of times the word “like” was said in the last 30 days, along with a count of the number of times it was said on each individual day in that 30 day period).

FIG. 2 provides an exemplary block diagram of the system 200 according to the present invention. System 200 may include one or more processors 204 in the form of (CPUs) 204A-204N, input/output circuitry 202, memory 208, and a sensory signal transmitter 206. Optionally, the system 200 may further include a network adapter for interfacing the system 200 with a network, such as the Internet, for transmitting data, which may include downloading software updates and/or uploading user data to a remote storage.

The processor 204 executes program instructions to carry out functions of the present invention, and may be provided as one or more microprocessors, microcontrollers, or processors in a system-on-chip, etc. FIG. 2 shows an example in which the system 200 is implemented as a single multi-processor system, in which multiple processors 204A-204N share system resources, such as memory 208, input/output circuitry 202, and sensory signal transmitter 206. In other examples, the system 200 may be implemented as a single processor system. Input/output circuitry 202 provides the capability to input data to, or output data from, system 200. For example, input/output circuitry may include input devices, such as microphones, sensors, keypads, touch screens, etc.; output devices, such as speakers and display screens; and/or input/output devices that provide the combined functionality of one or more of the foregoing input and output devices. Sensory signal transmitter 206 may be any device for transmitting a discreet sensory signal to a targeted user for informing the user of a detected instance of filler speech, which may include all such devices discussed herein.

Memory 208 stores program instructions that are executed by, and data that are used and processed by, the processor 204 to perform the functions of system 200. Memory 208 may include, for example, electronic memory devices, such as random-access memory (RAM), read-only memory (ROM), programmable read-only memory (PROM), electrically erasable programmable read-only memory (EEPROM), flash memory, etc. Memory 208 may include sensor data capture routines 210, signal processing routines 212, data processing routines 214, as well as stored data such as signal data 216, aggregate data 218, classification data 220, and an operating system 222.

Sensor data capture routines 210 may include routines to receive and process sensor input data, such as the capture of a user's speech at an input device 202, to form signal data 216. Signal processing routines 212 may include routines to process signal data 216, such text-classification models and acoustic-classification models, to form aggregate data 218 (e.g., conclusions on the detection of filler words and filler sounds, as discussed above). Data processing routines 214 may include routines to process aggregate data 218 for operation of the system 200 (e.g., instructing the sensory signal transmitter based on detection of filler speech). Classification data 220 may include stored listings of filler words and sound files for filler sounds and verified speaker voice recordings. Operating system 222 provides overall system functionality.

Working examples were created by using a CreateML tool from Apple, Inc. to train two text-classification models for detecting filler words and an acoustic-classification model for detecting filler sounds. The two text-classification models were trained to detect occurrences of the filler word “like”, and to further determine if each occurrence was a user of the word as filler speech or a use of the word in proper context.

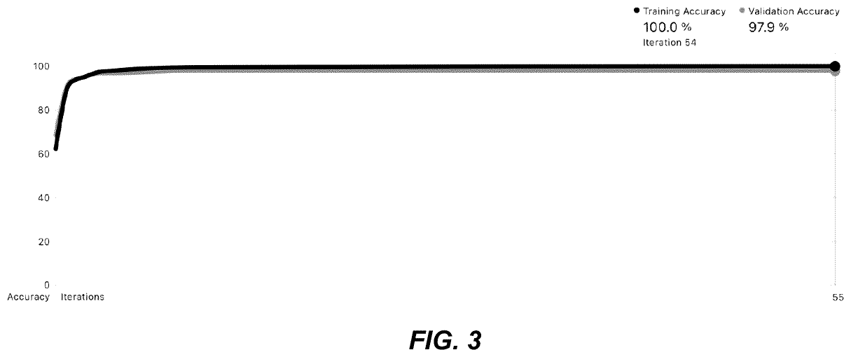

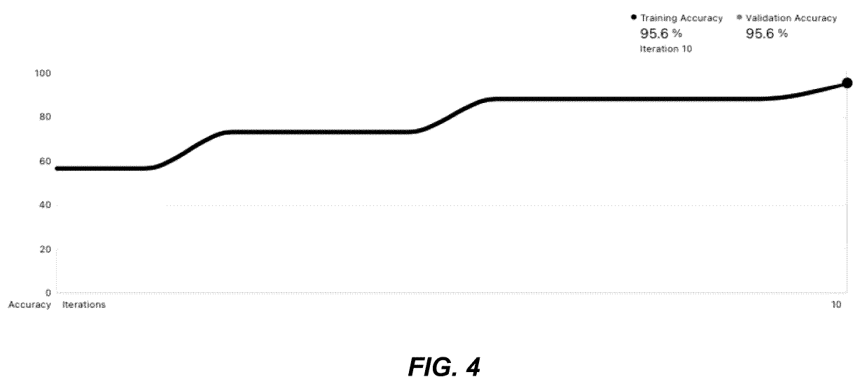

The first text-classification model used a “Transfer Learning BERT Embeddings” algorithm from the Apple iOS (versions 17+), and the second text-classification model used a “Conditional Random Field” algorithm from the Apple iOS (versions prior to 17). These models were trained with a Natural Language model to split a text-transcript into multiple words, with removal of punctuation, and with ChatGPT to then generate paragraphs in which the word “like” is used as a filler word and paragraphs where the word “like” is used in proper context. TTSMaker, a text-to-speech program, was then used to convert the paragraphs into audio signals that were input to the working examples, with the text-classification models set to detect all occurrences of the word “like”, capture the preceding three words and the subsequent three words for each occurrence, and then form sentences that were subsequently used for further training. FIG. 3 shows results for the first model, with a 95.6% accuracy (training and validation) achieved after ten iterations, and FIG. 4 shows results for the second model, with a 95.7% accuracy (training and validation) achieved after three iterations.

The acoustic-classification model for detecting filler sounds was trained from datasets of audio samples that were collected for multiple filler sounds (e.g., um, uh, and giggling/laughter), as well as datasets for background noise and speech. The datasets for background noise and speech were collected from a collection of sound samples from the Columbia University Sound Sample Database, which are made publicly available for use as “background noise” in composite audio signals for simulating real-world conditions, as well as from a collection of sound samples from Pixabay, a stock media website, which are made publicly available for use as ambient sound effects in a composite audio signal for simulating real-world conditions. All collected sound samples were mono channel, 16 khz, and 1 second in duration. Datasets were labeled and trained on the acoustic-classification model with the following parameters:
feature extractor: audio feature print
iterations: 55
window duration: 0.5
window overlap: 25%.

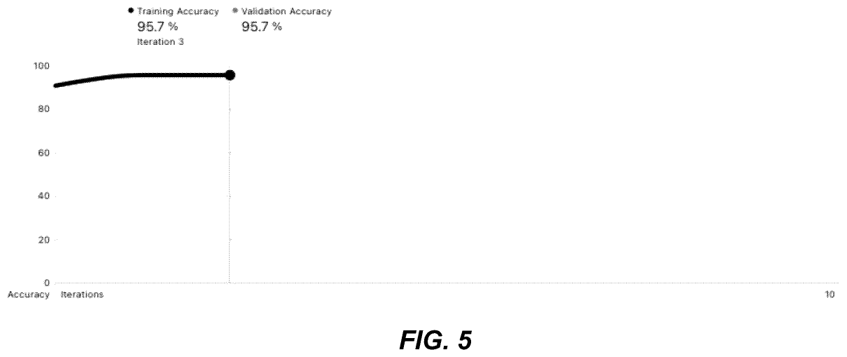

The model was trained using assemblyai_to determine occurrences of filler sounds in audio samples. A timestamp function was used to identify the beginning and ending of individual words in the audio signal, and the audio signal was split into discrete segments from which there was then identified individual occurrences of filler sounds such as “Um” and “Uh”. FIG. 5 shows results for the acoustic-classification model, with an accuracy (training and validation) quickly rising above 95% in early iterations and converging to an accuracy in a range of 97.9% (validation) to 100% (training) after 55 iterations.

Systems and methods according to the present invention provide invaluable benefits, including: real-time feedback to immediately identify instances of undesirable speaking behavior; continuous, uninterrupted monitoring and feedback throughout an entire day, including during spontaneous face-to-face conversations; real-time feedback to a targeted user in a discreet manner without risk of embarrassment; feedback that is recognizable to a targeted user while only minimally distracting or diverting the user's attention; and feedback that is not distracting, annoying, or recognizable by others. With these combined benefits, the present invention is expected to have far greater efficacy in correcting undesirable speech behavior beyond what is capable from conventional approaches that lack such benefits.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

As one example, though the foregoing disclosure and the accompanying figures address a system 200 in the form of a single device, it will be understood that the system 200 may be provided in a multi-device form, with two or more devices. A two-device system may be provided in which a first device performs a first portion of the functions (e.g., audio input, processing, analysis, and detection of filler speech) and a second device performs a second portion of the functions (e.g., delivering discreet sensory signal), with the two devices being in remote communication with one another (e.g., signal transmitters at both devices for the first device to instruct the second device when to deliver a sensory signal). A three-device system may be provided in which a first device performs a first portion of the functions (e.g., audio input and processing), a second device performs a second portion of the functions (e.g., signal analysis and detection of filler speech), and a third device performs a third portion of the functions (e.g., delivering discreet sensory signal), with the three devices being in remote communication with one another (e.g., signal transmitters at all three devices for transmitting signals amongst one another). Any other number of multi-device systems with four or more devices may also be provided. Such multi-device systems may be preferable in instances where the system 200 is configured for delivering a discreet sensory signal through an especially small sensory signal device (e.g., an earpiece; a clothing accessory; etc.) as division of the functional systems may enable complex computational work through a more robust remote server (e.g., a cloud server) while enabling more compact constructions of one or both of the audio input receiving device and/or the sensory signal generating device that may further facilitate positioning of those devices in closer proximity to a user's body.

The flowchart and block diagrams in the drawings illustrate the architecture, functionality, and operation of possible implementations of systems, methods, and computer program products according to various embodiments of the present invention. Each block in the flowchart or block diagrams may represent a module, segment, or portion of instructions, which comprises one or more executable instructions for implementing the specified logical function(s). In some implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

What is claimed is:

1. A system for providing speech-related feedback, comprising:
a processor, memory accessible by the processor, and programmed instructions and data stored in the memory and executable by the processor whereby the device is configured to:
receive an audio signal at an input device based on the speech of an individual within proximity of the system;
assess the audio signal for the presence of one or more instances of filler speech;
assess the audio signal to verify a speaker identity to determine if the audio signal originates from speech of a targeted user of the device; and
upon detecting the presence of at least one instance of filler speech and confirming that the audio signal originates from a verified targeted user of the device, outputting a discreet sensory signal to the targeted user informing them of the detection of filler speech.

2. The system of claim 1, wherein
the system is configured to assess the audio signal for detection of filler speech in the form of filler words and filler sounds, and to determine the presence of at least one instance of filler speech upon detecting the presence of at least one instance of either one or more filler words, one or more filler sounds, or a speaking pattern or behavior with one or more vocal disfluencies.

3. The system of claim 2, wherein
the system is configured to assess the audio signal for detection of filler words using a text-classification model, and assess the audio signal for detection of filler sounds using an acoustic-classification model.

4. The system of claim 1, wherein
the system is configured to assess the audio signal for detection of filler speech in the form of filler words.

5. The system of claim 4, wherein
the system is further configured to determine the context of a detected filler word to determine if the detected filler words was used in a proper non-filler context.

6. The system of claim 4, wherein
the system is configured to assess the audio signal for detection of filler words by:
converting the audio signal to a text transcript
text-searching the text transcript for words matching a predetermined list of filler words, the predetermined list of filler words being stored in the memory.

7. The system of claim 6, wherein
the system is further configured such, upon detecting a filler word in the text transcript, to identify surrounding words in proximity to the detected filler word and determining based on the surrounding words whether the detected filler word was used in a proper non-filler context.

8. The system of claim 6, wherein
the system is configured for a user to selectively update the predetermined list of filler words to either remove or add words.

9. The system of claim 1, wherein
the system is configured to assess the audio signal for detection of filler speech in the form of filler sounds.

10. The system of claim 9, wherein
the system is configured to assess the audio signal for detection of filler sounds by comparing a waveform of the audio signal to waveforms of sound files of predetermined filler sounds, the sound files of the predetermined filler sounds being stored in the memory.

11. The system of claim 10, wherein
the system is configured for a user to selectively update the sound files of predetermined filler sounds to either remove or add sound files.

12. The system of claim 1, wherein
the system is configured to verify speaker identity by comparing one or more waveforms of the audio signal to one or more waveforms from sound files of user voice recordings, the sound files of the user voice recordings being stored in the memory.

13. The system of claim 1, wherein
the system is configured to output discreet sensory signals in the form of one or more of: haptic signals, auditory signals, and visual signals.

14. The system of claim 1, wherein
the system is configured to record a history of detected filler speech for review by a user.
